(19) United States
(12) Patent Application Publication
(10) Pub. No.: US 2019/0018925 A1
(43) Pub. Date: Jan. 17, 2019

(54) IDENTIFYING SMALL SCALE VARIATIONS ACROSS SETS OF BACTERIAL GENOMES

(71) Applicant: International Business Machines Corporation, Armonk, NY (US)

(72) Inventors: Thomas C. Conway, Heidelberg West (AU); Benjamin Goudey, East Melbourne (AU)

(21) Appl. No.: 15/646,593

(22) Filed: Jul. 11, 2017

(51) Int. Cl. G06F 19/22; G06F 19/12; G06F 19/28

(52) U.S. Cl. CPC G06F 19/22; G06F 19/28; G06F 19/12

(57) ABSTRACT

One or more sequences are decomposed into one or more fixed length subsequences. The one or more sequences are associated with one or more respective genome samples. One or more contiguous ranges of the one or more fixed length subsequences are identified. A given one of the one or more contiguous ranges is analyzed to identify at least one group of variants of the fixed length subsequences within the given contiguous range. Analyzing the given contiguous range to identify the at least one group of variants comprises comparing the one or more fixed length subsequences of the given contiguous range to each other. It is determined whether the at least one group of variants partitions the one or more genome samples in satisfaction of at least one partitioning criterion.

### BACKGROUND

Genomics is a scientific field concerned with the structure, function, evolution and mapping of genomes. A genome is a complete set of DNA within a single cell of an organism. Bacterial genomics, for example, may be used to study bacterial evolution, bacterial epidemics, etc. A common problem in the field of bacterial genomics is the identification of differences within a collection of organisms of the same species. Such points of difference may be used for such purposes as, for example, identifying outbreaks of pathogenic bacteria, tracking transmission of pathogens within hospitals and analyzing the emergence of particular forms of antibiotic drug resistance. The points of difference may comprise, for example, single nucleotide variations (SNVs), insertions or deletions (indels), and/or rearrangements due to translocation of sections of the DNA sequence (i.e., where sections of the DNA sequence have moved) or inversion of sections of the DNA sequence (i.e., where sections of the DNA sequence have exchanged direction).

### SUMMARY

Embodiments of the invention provide techniques for identifying variations across sets of bacterial genomes.

For example, in one embodiment, a method for identifying variations across a collection comprises the following steps. One or more sequences are decomposed into one or more fixed length subsequences. The one or more sequences are associated with one or more respective genome samples. One or more contiguous ranges of the one or more fixed length subsequences are identified. A given one of the one or more contiguous ranges is analyzed to identify at least one group of variants of the fixed length subsequences within the given contiguous range. Analyzing the given contiguous range to identify the at least one group of variants comprises comparing the one or more fixed length subsequences of the given contiguous range to each other. It is determined whether the at least one group of variants partitions the one or more genome samples in satisfaction of at least one partitioning criterion. The steps of the method are implemented by at least one processing device comprising a processor operatively coupled to a memory.

As another example, in one embodiment, an article of manufacture comprises a processor-readable storage medium having encoded therein executable code of one or more software programs. The one or more software programs when executed by the one or more processors implement steps of: decomposing one or more sequences into one or more fixed length subsequences, wherein the one or more sequences are associated with one or more respective genome samples; identifying one or more contiguous ranges of the one or more fixed length subsequences; analyzing a given one of the one or more contiguous ranges to identify at least one group of variants of the fixed length subsequences within the given contiguous range, wherein analyzing the given contiguous range to identify the at least one group of variants comprises comparing the one or more fixed length subsequences of the given contiguous range to each other; and determining whether the at least one group of variants partitions the one or more genome samples in satisfaction of at least one partitioning criterion.

As yet another example, in one embodiment, an apparatus comprises at least one processor and a memory operatively coupled to the processor. The processor is configured to: decompose one or more sequences into one or more fixed length subsequences, wherein the one or more sequences are associated with one or more respective genome samples; identify one or more contiguous ranges of the one or more fixed length subsequences; analyze a given one of the one or more contiguous ranges to identify at least one group of variants of the fixed length subsequences within the given contiguous range, wherein, in analyzing the given contiguous range to identify the at least one group of variants, the processor is configured to compare the one or more fixed length subsequences of the given contiguous range to each other; and determine whether the at least one group of variants partitions the one or more genome samples in satisfaction of at least one partitioning criterion.

Advantageously, illustrative embodiments provide methodologies for analysis of biological sequences including, but not limited to, identification and typing (e.g., genetic and/or proteomic characterization) of organisms.

These and other objects, features, and advantages of the present invention will become apparent from the following detailed description of illustrative embodiments thereof, which is to be read in connection with the accompanying drawings.

### BRIEF DESCRIPTION OF THE DRAWINGS

Exemplary embodiments of the present invention will be described below in more detail, with reference to the accompanying drawings, of which:

FIG. 1 illustrates a process for identifying variations across sets of bacterial genomes according to an embodiment of the invention.

FIG. 2 illustrates a block diagram of a system with which one or more embodiments of the invention are implemented.

FIG. 3 illustrates a computer system in accordance with which one or more components/steps of techniques of the invention may be implemented according to an embodiment of the invention.

FIG. 4 illustrates a cloud computing environment according to an embodiment of the invention.

FIG. 5 illustrates abstraction model layers according to an embodiment of the invention.

### DETAILED DESCRIPTION

The emergence of high throughput sequencing technologies for sequencing DNA have enabled the collection of unprecedented volumes of high resolution data that can allow for the discrimination between samples at the individual nucleotide level. Conventional methods for analyzing this data, comprising short sequences called “sequence reads” or “reads” derived from an initial DNA sample, fall into two families: reference-based approaches and reference-free approaches. In both cases, the method may involve an initial step of assembling the sequence reads into “contigs” by analyzing how they overlap.

As used herein, a “read” can refer to a text string indicating the order of bases in a DNA sequence. Reads can be short compared to the length of a genome so that the reads must be assembled into longer contigs. Reads are used to reconstruct an original sequence.

As used herein, “contig” can refer to a set of overlapping DNA segments that together represent a consensus region of DNA. A contig can refer to overlapping sequence data in bottom-up sequencing, and to overlapping clones that form a physical map of a genome that is used to guide sequencing and assembly in top-down sequencing. Contigs may, therefore, refer to overlapping DNA sequence and to overlapping physical segments (fragments) contained in clones depending on the context. A sequence contig can refer to a continuous sequence resulting from the reassembly of small DNA fragments generated by bottom-up sequencing strategies.

In the case of reference-based methods, the reads (or the contigs) are aligned to one or more reference sequences to determine where the reads best match the reference sequences. The alignment allows for the alignment of discrepancies between the reference sequence and the sequence reads (or the contigs). In places where the discrepancies between the reads from a sample are consistent, it may be concluded that the DNA sequence in the underlying sample varies from the reference sequence it was aligned to. If the contigs, rather than the reads, are being aligned, the method does not need to determine if the discrepancies are consistent, since this is implicitly done in the assembly process where consistent overlaps between reads are detected. This process may be repeated for a collection of samples, and the places where variations are identified can be collated and used for downstream analysis.

In contrast, reference-free methods do not presuppose the existence of one or more reference sequences. Rather, they compare the information in the sequences by decomposing reads (or contigs) into a set of shorter fixed length subsequences (e.g., k-mers). The shorter fixed length subsequences are then collated and analyzed to determine which of the shorter fixed length subsequences represent points of variation between samples. Typically, pairs of the fixed length subsequences are sought such that they only differ in the middle nucleotide, such as, for example, in the kSNP v2 software for alignment free single nucleotide polymorphism (SNP) discovery and phylogenetics of hundreds of microbial genomes A discussion of kSNP techniques can be found in Gardner, S. N. and Hall, B. G., “When whole-genome alignments just won't work: kSNP v2 software for alignment-free SNP discovery and phylogenetics of hundreds of microbial genomes.” PLoS ONE, 8(12):e81760.doi:10.1371/journal.pone.0081760 (2013), which is incorporated-by-reference herein in its entirety. Reference-free detection of isolated SNPs is performed by interpreting the fixed length subsequences as a de Bruijn graph, and then detecting structural features corresponding to variants.

A significant limitation of these prior reference-free methods is that they are limited in what SNVs they can detect, and cannot detect short indel variations. Moreover, these reference-free methods require the SNVs to be isolated. That is, they will not detect SNVs present in the samples which are close to other SNVs (e.g., within k/2 nucleotides). In addition, due to the nature of the conventional methods, which need access to all sequence data for genome samples during a given operation, relatively large amounts of computer memory are needed to hold all of the sequence data for the genome samples at the same time. Furthermore, the conventional algorithms are super-linear in scale. For example, if the number of samples doubles (i.e., the scale doubles), the amount of required computer processing will more than double. Accordingly, the applicability of these prior reference-free methods is greatly limited.

Illustrative embodiments of the present invention provide for a novel reference-free approach for identifying variations between samples of genomes in which SNVs and indels may be detected, even if they are in close proximity to other points of variation. An embodiment of the present invention utilizes k-mers, which may be derived from sequence reads and/or assembled contigs. The data from the samples can be collated in two parts: a sorted list comprised of all the k-mers present across the collection of samples, and a matrix which indicates for each k-mer, in which samples they occurred. A method, in accordance with an embodiment, involves finding ranges in the sorted list of k-mers, which may contain one or more groups of k-mers which are variants of one another. The k-mers in this range are then compared to one another to identify the groups of variants, and for each group, the method then determines whether the group is applicable as a descriptive variant over the collection of samples.

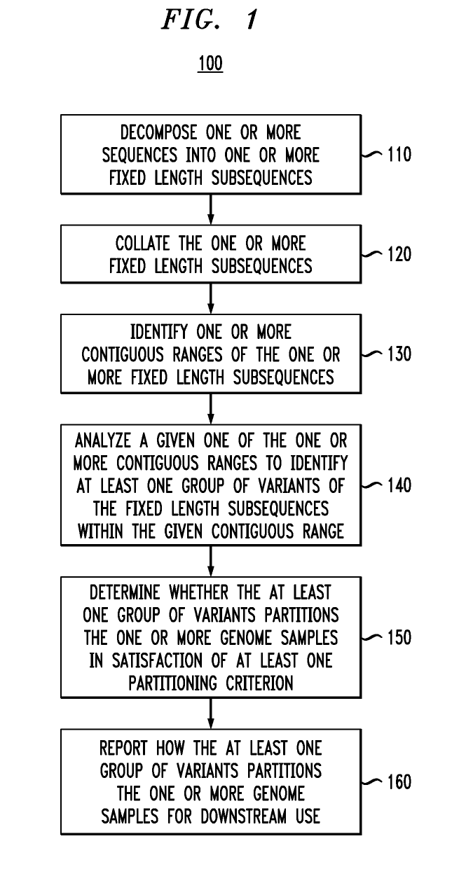

With reference to FIG. 1, a flowchart 100 is provided illustrating an exemplary process for identifying variations across sets of genomes. In one embodiment, the genomes are bacterial genomes.

At step 110, one or more sequences are decomposed into one or more shorter fixed length subsequences. The one or more sequences are associated with one or more respective genome samples, and may comprise at least one of a read and a contig.

In one embodiment, the one or more shorter fixed length subsequences are k-mers. As is known in the art, a k-mer refers to all of the possible subsequences, of length k, from a read obtained through sequencing. For example, k-mers can include, but are not necessarily limited to, short fixed length subsequences extracted from a DNA sequence of a sample. The samples can include, but are not necessarily limited to, skin swab samples (e.g., taken from lesions on a body), and bacterial samples (e.g., staphylococcus (staph) and salmonella) taken from hospital patients, governmental sources, health laboratories, etc., or other samples requiring analysis. The embodiments of the present invention are agnostic to the source of the samples, and can be used to draw conclusions on samples from the same or different species. At step 120, the one or more shorter fixed length subsequences are collated.

In one embodiment, collating the one or more fixed length subsequences comprises generating a sorted list of the one or more fixed length subsequences. The sorted list of the one or more fixed length subsequences may comprise, for example, a compressed list in sorted order, an uncompressed list in sorted order, or a compressed rank and select data structure representation. The compressed rank and select representation may be in its entirety, or may be projected onto a subset of the one or more fixed length subsequences by excluding fixed length subsequences that only occur in a subset of the genome samples.

As used herein, a “rank and select data structure” can refer to a data representation that supports rank and select operations, as described in, for example, Jacobson, Guy, “Space-efficient static trees and graphs,” Proceedings of the 30th Annual Symposium on Foundations of Computer Science, pages 549-554 (IEEE, 1989), which is incorporated-by-reference herein in its entirety.

In one embodiment, collating the one or more fixed length subsequences further comprises composing a matrix comprising information associated with each of the one or more fixed length subsequences. The matrix may comprise information indicating, for each of the one or more fixed length subsequences, in which of the one or more genome samples the fixed length subsequence occurs. The matrix may be represented by, for example, a bit matrix (e.g., row or column major representations), an inverted index, or a compressed rank and select data structure. For example, a row in a matrix can correspond to a k-mer and a column can correspond to a true or false variable with respect to a given inquiry, providing information on whether there are any feasible variances between samples.

At step 130, one or more contiguous ranges of the one or more fixed length subsequences are identified. For example, the one or more contiguous ranges may be identified from the sorted list generated during the collating of the one or more fixed length subsequences at step 120. In one embodiment, identifying the one or more contiguous ranges of the one or more fixed length subsequences comprises performing recursive subdivision at increased prefix length until a range size is less than a threshold size, and identifying the contiguous ranges that share an exact prefix length (e.g., a shared prefix of a defined length).

At step 140, a given one of the one or more contiguous ranges is analyzed to identify at least one group of variants of the fixed length subsequences within the given contiguous range. For example, ranges of contiguous k-mers are identified to be analyzed to determine groups of variant k-mers. For each range, the k-mers are compared with each other to find and group together k-mers that are determined to be feasible variant groups (i.e., true variants of each other). Accordingly, analyzing the given contiguous range to identify the at least one group of variants comprises comparing the one or more fixed length subsequences (e.g., k-mers) of the given contiguous range to each other.

For example, k-mers are extracted from samples and compared to each other in order to determine differences between the samples. In accordance with an embodiment of the present invention, k-mers are collected in order so that similar k-mers are next to each other, and the groups of k-mers are analyzed to determine instances of variation between them. In other words, embodiments of the present invention look for areas that differentiate within a group of k-mers. The determined differences are used in downstream analysis (e.g., downstream machine learning) to train classifiers of certain scenarios, such as, but not necessarily limited to, which samples are highly pathogenic and/or virulent, what strains may be related (e.g., in the same family tree) or unrelated, whether the samples can be clustered together as part of an outbreak, and other epidemiological purposes.

In one embodiment, analyzing the given contiguous range to identify the at least one group of variants further comprises employing one or more of a disjoint set (e.g., union/find) method and an index method to group the k-mers.

The one or more fixed length subsequences may be compared with each other based on one or more of, for example, Hamming distance, Levenshtein distance, and masking and hashing. Generally speaking, the Hamming distance between a first string and a second string (e.g., a first fixed length subsequence and a second fixed length subsequence) of equal length is the minimum number of substitutions required to change the first string into the second string. Generally speaking, the Levenshtein distance calculates the distance between a first string and a second string (e.g., a first fixed length subsequence and a second fixed length subsequence) as the minimum number of single-character edits (i.e., insertions, deletions and/or substitutions) required to change the first string to the second string. The Needleman-Wunsch algorithm or Smith-Waterman algorithm may be used perform alignment of the fixed length subsequences. The Hamming and Levenshtein distances can be determined for all pairs. The masking and hashing may be of all pairs or indexed. Specific details regarding these algorithms are known in the art, and further details will not be provided herein.

At step 150, it is determined whether the at least one group of variants partitions the one or more genome samples in satisfaction of at least one partitioning criterion. The matrix composed during the collating at step 120 may be consulted to perform the determination at step 150. In other words, the matrix can be consulted to determine if a variant group forms a valid partitioning of the samples. In one embodiment, the determination at step 150 comprises determining how the at least one group of variants partitions the one or more genome samples. Determining how the at least one group of variants partitions the one or more genome samples may comprise identifying a type of variant for each of the one or more genome samples. For example, for each of the one or more samples, it is determined whether the sample comprises a null variant (i.e., none of the k-mers), a simple variant (i.e., exactly one of the k-mers) or an ambiguous variant (i.e., more than one of the k-mers).

After identifying the type of variant for each of the one or more genome samples, a partitioning of the one or more genome samples may be determined for the at least one group of variants. For example, the at least one group of variants is determined to be: (1) a complete partition of the one or more genome samples in response to determining that each of the one or more genome samples comprises the simple variant; (2) a partial partition of the one or more genome samples in response to determining that the one or more genome samples comprise either the simple variant or the null variant (i.e., determining that a first portion of the one or more genome samples comprises the simple variant and a second portion of the one or more genome samples comprises the null variant); or (3) an ambiguous partition of the one or more genome samples in response to determining that at least one of the one or more genome samples comprises the ambiguous variant.

At step 160, how the at least one group of variants partitions the one or more genome samples is reported for downstream use. For example, in response to determining that the at least one group of variants is a complete partition of the one or more genome samples, the at least one group of variants is reported for downstream use. Downstream use can include, for example, using the results in machine learning techniques to perform genetic analysis to be able to predict conditions from future samples. Machine learning algorithms used can include, but are not necessarily limited to, a Support Vector Machine (SVM), a Multilayer Perceptron (MLP), a deep learning model and/or a neural network.

The process of FIG. 1 may be implemented to detect SNVs and/or short indel variations across a collection of genomes. As mentioned above, prior conventional reference-free methods for identifying variations across genomes suffer from limitations, such as that they cannot detect short indel variations, and they require the SNVs to be isolated. In addition, unlike conventional methods, because the techniques of the embodiments of the present invention only need access to portions and do not need access to all sequence data for genome samples during a given operation, smaller amounts of computer memory are needed than with conventional methods. Furthermore, the techniques of the embodiments of the present invention scale better than conventional methods to large numbers of samples (e.g., thousands of samples) and are not super-linear. Accordingly, the embodiments of the present invention provide novel methods for identifying variations across genomes that represents an improvement in the field of computer technology, and more specifically, computer technology as it applies to genomics.

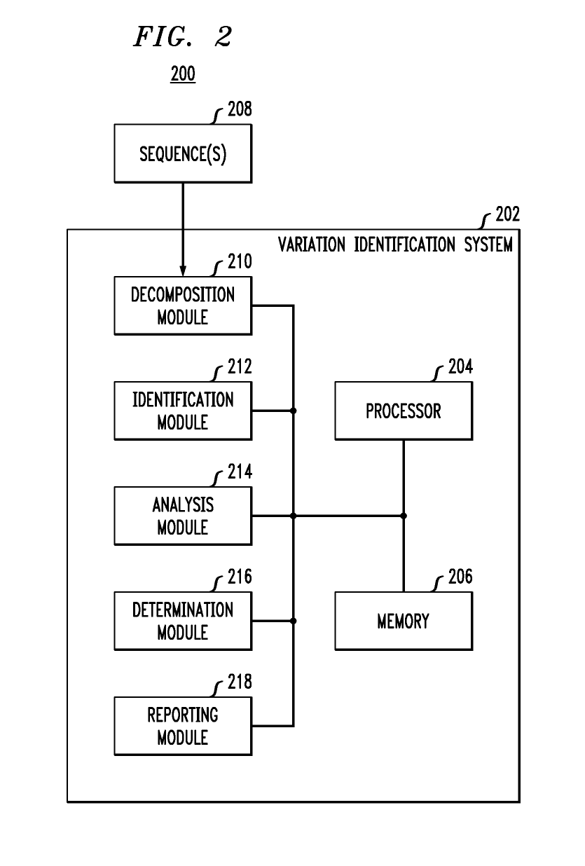

FIG. 2 illustrates a block diagram of an exemplary system 200 to identify variations across sets of genomes. As shown, system 200 comprises processing device 202 comprising processor 204 operatively coupled to memory 206. In one embodiment, processing device 202 comprises a server.

Processing device 202 further comprises a set of modules operatively coupled to processor 204 and memory 206. In this illustrative embodiment, the set of modules include decomposition module 210, identification module 212, suggestion module 214, determination module 216 and reporting module 218. Although each module 210-218 is shown as an individual module, the functionality of each module may be embodied as a single module, or as a combination of sub-combinations of modules. Accordingly, the organization of the modules depicted in FIG. 2 is not to be considered limiting.

Decomposition module 210 is configured to decompose one or more sequences associated with one or more respective genome samples, such as sequence(s) 208, into one or more shorter fixed length subsequences, as discussed with reference to FIG. 1. In one embodiment, decomposition module 210 is further configured to collate the one or more shorter fixed length subsequences by generating a sorted list of the one or more shorter fixed length subsequences and composing a matrix comprising information associated with each of the one or more shorter fixed length subsequences, as discussed with reference to FIG. 1.

Identification module 212 is configured to identify one or more contiguous ranges of the one or more fixed length subsequences, as discussed with reference to FIG. 1.

Analysis module 214 is configured to analyze a given one of the one or more contiguous ranges to identify at least one group of variants of the fixed length subsequences within the given contiguous range by comparing the one or more fixed length subsequences of the given contiguous range to each other, as discussed with reference to FIG. 1.

Determination module 216 is configured to determine whether the at least one group of variants partitions the one or more genome samples in satisfaction of at least one partitioning criterion, as discussed with reference to FIG. 1.

Reporting module 218 is configured to report the at least one group of variants for downstream use, for example, in response to a determination that the at least one group of variants is a complete partition of the one or more genome samples, as discussed with reference to FIG. 1.

As shown in FIG. 2 by lines and/or arrows, the components of the system 200 are operatively connected to each other via, for example, physical connections, such as wired and/or direct electrical contact connections, and/or wireless connections, such as, for example, WiFi, BLUETOOTH, IEEE 802.11, and/or networks, including but not limited to, a local area network (LAN), wide area network (WAN), cellular network, ad hoc networks, WANET, satellite network or the Internet.

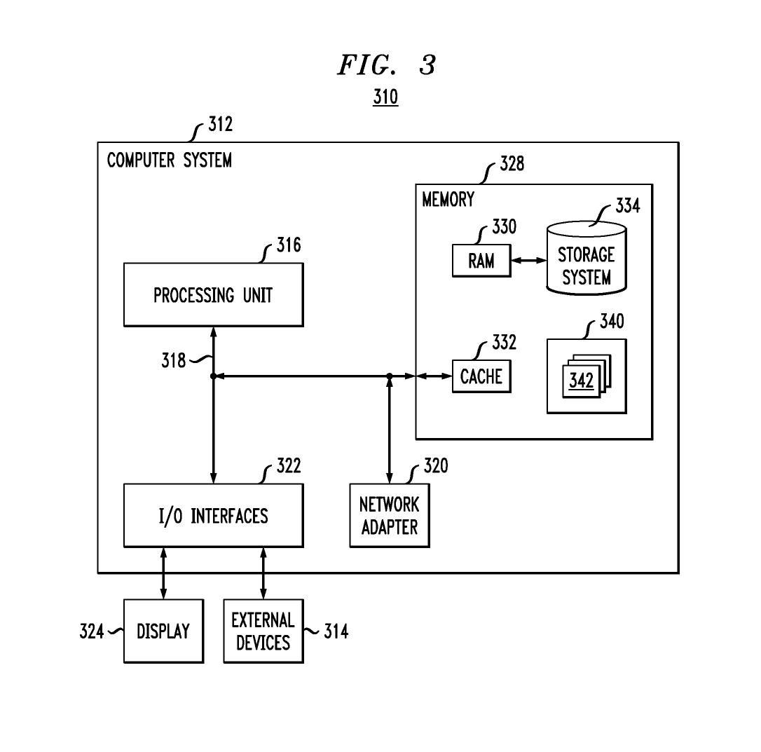

One or more embodiments can make use of software running on a computer or workstation. With reference to FIG. 3, in a computing node 310 there is a system/server 312, which is operational with numerous other general purpose or special purpose computing system environments or configurations. Examples of well-known computing systems, environments, and/or configurations that may be suitable for use with system/server 312 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

System/server 312 may be described in the general context of computer system executable instructions, such as program modules, being executed by a computer system. Generally, program modules may include routines, programs, objects, components, logic, data structures, and so on that perform particular tasks or implement particular abstract data types. System/server 312 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, system/server 312 is shown in the form of a computing device. The components of system/server 312 may include, but are not limited to, one or more processors or processing units 316, system memory 328, and bus 318 that couples various system components including system memory 328 to processor 316.

Bus 318 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

System/server 312 typically includes a variety of computer system readable media. Such media may be any available media that is accessible by system/server 312, and it includes both volatile and non-volatile media, removable and non-removable media.

The system memory 328 can include computer system readable media in the form of volatile memory, such as random access memory (RAM) 330 and/or cache memory 332. System/server 312 may further include other removable/non-removable, volatile/nonvolatile computer system storage media. By way of example only, storage system 334 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 318 by one or more data media interfaces.

As depicted and described herein, memory 328 may include at least one program product having a set (e.g., at least one) of program modules that are configured to carry out the functions of embodiments of the invention. A program/utility 340, having a set (at least one) of program modules 342, may be stored in memory 328 by way of example, and not limitation, as well as an operating system, one or more application programs, other program modules, and program data. Each of the operating system, one or more application programs, other program modules, and program data or some combination thereof, may include an implementation of a networking environment. Program modules 342 generally carry out the functions and/or methodologies of embodiments of the invention as described herein.

System/server 312 may also communicate with one or more external devices 314 such as a keyboard, a pointing device, an external data storage device (e.g., a USB drive), display 324, one or more devices that enable a user to interact with system/server 312, and/or any devices (e.g., network card, modem, etc.) that enable system/server 312 to communicate with one or more other computing devices. Such communication can occur via I/O interfaces 322. Still yet, system/server 312 can communicate with one or more networks such as a LAN, a general WAN, and/or a public network (e.g., the Internet) via network adapter 320. As depicted, network adapter 320 communicates with the other components of system/server 312 via bus 318. It should be understood that although not shown, other hardware and/or software components could be used in conjunction with system/server 312. Examples include, but are not limited to, microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

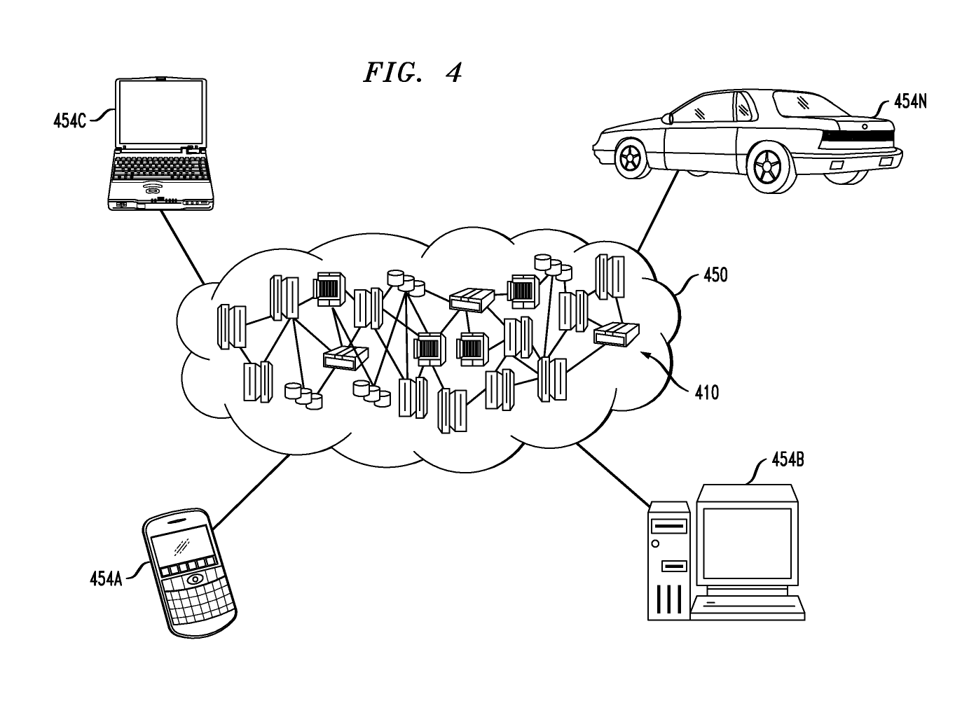

Referring now to FIG. 4, illustrative cloud computing environment 450 is depicted. As shown, cloud computing environment 450 includes one or more cloud computing nodes 410 with which local computing devices used by cloud consumers, such as, for example, personal digital assistant (PDA) or cellular telephone 454A, desktop computer 454B, laptop computer 454C, and/or automobile computer system 454N may communicate. Nodes 410 may communicate with one another. They may be grouped (not shown) physically or virtually, in one or more networks, such as Private, Community, Public, or Hybrid clouds as described hereinabove, or a combination thereof. This allows cloud computing environment 450 to offer infrastructure, platforms and/or software as services for which a cloud consumer does not need to maintain resources on a local computing device. It is understood that the types of computing devices 454A-N shown in FIG. 4 are intended to be illustrative only and that computing nodes 410 and cloud computing environment 450 can communicate with any type of computerized device over any type of network and/or network addressable connection (e.g., using a web browser).

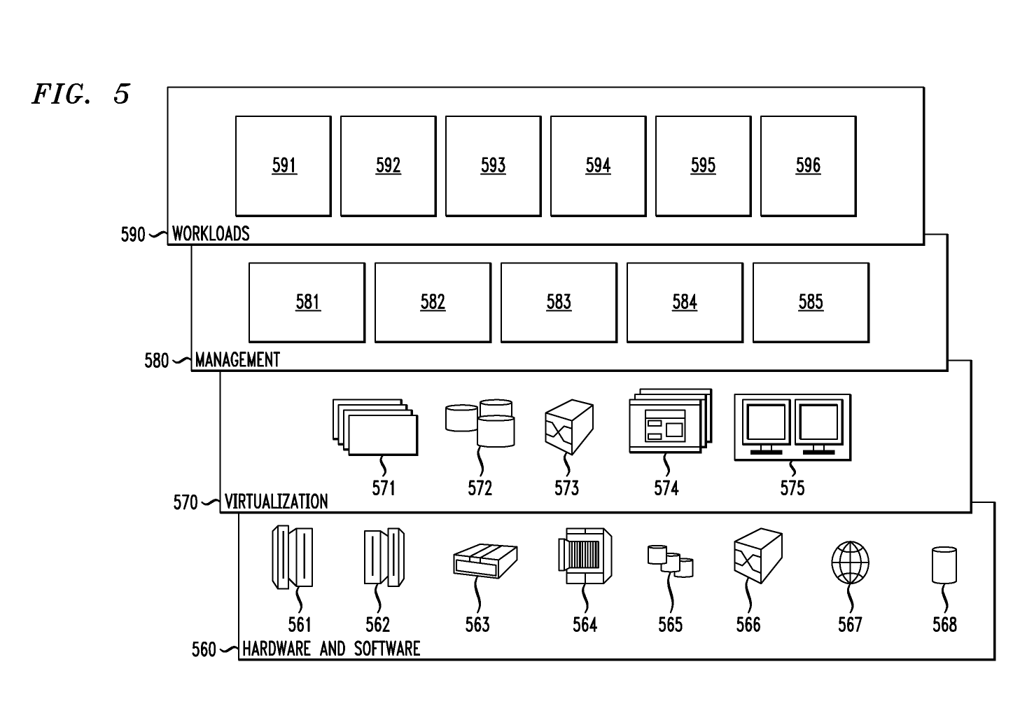

Referring now to FIG. 5, a set of functional abstraction layers provided by cloud computing environment 450 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 560 includes hardware and software components. Examples of hardware components include: mainframes 561; RISC (Reduced Instruction Set Computer) architecture based servers 562; servers 563; blade servers 564; storage devices 565; and networks and networking components 566. In some embodiments, software components include network application server software 567 and database software 568.

Virtualization layer 570 provides an abstraction layer from which the following examples of virtual entities may be provided: virtual servers 571; virtual storage 572; virtual networks 573, including virtual private networks; virtual applications and operating systems 574; and virtual clients 575.

In one example, management layer 580 may provide the functions described below. Resource provisioning 581 provides dynamic procurement of computing resources and other resources that are utilized to perform tasks within the cloud computing environment. Metering and Pricing 582 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 583 provides access to the cloud computing environment for consumers and system administrators. Service level management 584 provides cloud computing resource allocation and management such that required service levels are met. Service Level Agreement (SLA) planning and fulfillment 585 provide pre-arrangement for, and procurement of, cloud computing resources for which a future requirement is anticipated in accordance with an SLA.

Workloads layer 590 provides examples of functionality for which the cloud computing environment may be utilized. Examples of workloads and functions which may be provided from this layer include: sequence decomposition 591; software development and lifecycle management 592; data analysis 593; data processing 594; transaction processing 595; and variation identification 596, which may perform various functions described above.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although illustrative embodiments have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for identifying variations across a collection of genomes, the method comprising:
decomposing one or more sequences into one or more fixed length subsequences, wherein the one or more sequences are associated with one or more respective genome samples;
identifying one or more contiguous ranges of the one or more fixed length subsequences;
analyzing a given one of the one or more contiguous ranges to identify at least one group of variants of the fixed length subsequences within the given contiguous range, wherein analyzing the given contiguous range to identify the at least one group of variants comprises comparing the one or more fixed length subsequences of the given contiguous range to each other; and
determining whether the at least one group of variants partitions the one or more genome samples in satisfaction of at least one partitioning criterion;
wherein the steps of the method are implemented by at least one processing device comprising a processor operatively coupled to a memory.

2. The method of claim 1, wherein the one or more sequences comprise at least one of a read and a contig.

3. The method of claim 1, wherein the one or more fixed length subsequences comprise k-mers.

4. The method of claim 1, further comprising collating the one or more fixed length subsequences.

5. The method of claim 4, wherein collating the one or more fixed length subsequences comprises generating a sorted list of the one or more fixed length subsequences, and wherein the one or more contiguous ranges are identified from the sorted list.

6. The method of claim 5, wherein the sorted list of the one or more fixed length subsequences comprises one of a compressed list in sorted order and an uncompressed list in sorted order.

7. The method of claim 5, wherein the sorted list of the one or more fixed length subsequences comprises a compressed rank and select data structure

8. The method of claim 4, wherein collating the one or more fixed length subsequences further comprises generating a matrix comprising information associated with each of the one or more fixed length subsequences.

9. The method of claim 8, wherein the matrix comprises information indicating, for each of the one or more fixed length subsequences, in which of the one or more genome samples the fixed length subsequence occurs.

10. The method of claim 8, wherein the matrix is represented by one of a bit matrix, an inverted index, and a compressed rank and select data structure.

11. The method of claim 8, further comprising referencing the matrix to determine whether the at least one variant group forms a valid partitioning of the one or more genome samples.

12. The method of claim 1, wherein identifying the one or more contiguous ranges of the one or more fixed length subsequences comprises performing recursive subdivision at increasing prefix length until a range size is less than a threshold size, and identifying the one or more contiguous ranges that share an exact prefix length.

13. The method of claim 1, wherein the one or more fixed length subsequences are compared with each other based on one or more of Hamming distance, Levenshtein distance, and masking and hashing.

14. The method of claim 1, wherein analyzing the given contiguous range to identify the at least one group of variants comprises employing one or more of a disjoint set method and an index method.

15. The method of claim 1, wherein determining whether the at least one group of variants partitions the one or more genome samples in satisfaction of a partitioning criterion comprises determining how the at least one group of variants partitions the one or more genome samples.

16. The method of claim 15, wherein determining how the at least one group of variants partitions the one or more genome samples comprises identifying, for each of the one of the one or more genome samples, whether the sample comprises a null variant, a simple variant or an ambiguous variant.

17. The method of claim 16, wherein the at least one group of variants is determined to be:
a complete partition of the one or more genome samples in response to determining that each of the one or more genome samples comprises the simple variant;
a partial partition of the one or more genome samples in response to determining that a first portion of the one or more genome samples comprises the simple variant and a second portion of the one or more genome samples comprises the null variant; and
an ambiguous partition of the one or more genome samples in response to determining that at least one of the one or more genome samples comprises the ambiguous variant.

18. The method of claim 17, further comprising reporting how the at least one group of variants partitions the one or more genome samples for downstream use.

19. An article of manufacture configured to identify variations across a collection of genomes, the article of manufacture comprising a processor-readable storage medium having encoded therein executable code of one or more software programs, wherein the one or more software programs when executed by the one or more processors implement the steps of:
decomposing one or more sequences into one or more fixed length subsequences, wherein the one or more sequences are associated with one or more respective genome samples;
identifying one or more contiguous ranges of the one or more fixed length subsequences;
analyzing a given one of the one or more contiguous ranges to identify at least one group of variants of the fixed length subsequences within the given contiguous range, wherein analyzing the given contiguous range to identify the at least one group of variants comprises comparing the one or more fixed length subsequences of the given contiguous range to each other; and
determining whether the at least one group of variants partitions the one or more genome samples in satisfaction of at least one partitioning criterion.

20. An apparatus configured to identify variations across a collection of genomes, the apparatus comprising:
at least one processing device comprising a processor operatively coupled to a memory and configured to:
decompose one or more sequences into one or more fixed length subsequences, wherein the one or more sequences are associated with one or more respective genome samples;
identify one or more contiguous ranges of the one or more fixed length subsequences;
analyze a given one of the one or more contiguous ranges to identify at least one group of variants of the fixed length subsequences within the given contiguous range, wherein, in analyzing the given contiguous range to identify the at least one group of variants, the processor is configured to compare the one or more fixed length subsequences of the given contiguous range to each other; and
determine whether the at least one group of variants partitions the one or more genome samples in satisfaction of at least one partitioning criterion.
